(19) United States
(12) Patent Application Publication
(10) Pub. No.: US 2019/0367280 A1
(43) Pub. Date: Dec. 5, 2019

(54) CONVEYOR BELT COMPRISING INTERLOCKING PLATES HAVING A STAKED-END

(71) Applicant: PRINCE CASTLE LLC, Carol Stream, IL (US)

(72) Inventor: Richard Bauer, Bauer, IL (US)

(21) Appl. No.: 15/996,013

(22) Filed: Jun. 1, 2018

(51) Int. Cl. B65G 17/06; B65G 15/30

(52) U.S. Cl. CPC B65G 17/068; B65G 2201/0202; B65G 17/064; B65G 15/30

(57) ABSTRACT

A conveyor belt system includes a conveyor belt having a slat connection mechanism such as a plurality of rods or a plurality of rivets, and a plurality of slats. At least one of the slats in the plurality of slats includes a connection element extending from one end of a flat body portion, the connection element extending downward from a flat body portion in direction that is substantially perpendicular to a top surface and substantially perpendicular to a leading edge. The connection element includes a first planar portion and a second planar portion, the first planar portion being offset from, but substantially parallel to, the second planar portion.

### FIELD OF THE INVENTION

The disclosure is generally directed to a conveyor belt for conveying food items. More specifically, the disclosure is directed to conveyor belt slats or plates that interlock with one another by staked-ends of the plates.

### BACKGROUND

In the food service industry food items are often prepared, at least partially, by placing the food items on a conveyor belt that transports the food items into a food preparation or cooking device, such as a toaster or oven. Such toasters and ovens may include a heating device, such as a heated platen, and a slowly rotating conveyor belt. The conveyor belt holds the food item in close proximity to the platen while the conveyor belt simultaneously transports the food item through the preparation or cooking device. The length of time the food item is exposed to the heated platen may vary based on the length of the platen and the speed of the conveyor belt. Such toasters may process food items continuously as opposed to household toasters that process food items in batch mode, such as two or four pieces of bread at a time. Conveyor toasters are ill-suited for consumer use because of their size, manufacturing cost, power requirements, and the time required to pre-heat the platen to operating temperature. However, conveyor toasters are preferred by restaurants and food services that require high-volume through-put and consistent heating/toasting.

Conveyor toasters generally include a wire conveyor belt. Wire conveyor belts are ideal for handling, cooking, icing, slicing, breading, cooling, filling, inspecting, and packing of products like breads, rolls, buns, donuts, confections, cakes, pies, pastries, meat, seafood, poultry, and other processed foods. The simple, open design of wire conveyor belts provides efficient operation with minimum maintenance and easy cleanup to meet sanitation requirements. One such known wire conveyor belt is illustrated in FIGS. 1 and 2. The wire conveyor belt 10 may include a plurality of spaced metal rods 16 interconnected by coupling “hook” and “loop” connection elements 18, 20 formed at the rod ends of adjacent metal rods 16. The rods 16 may support a food item and the rods 16 may hold the components of the belt together by way of the interconnected hook and loop connection elements 18, 20. Other types of wire conveyor belts may include spaced adjacent metal rods as well.

One known conveyor belt, for example, is the wire conveyor belt disclosed in U.S. Pat. No. 7,987,972, which is herein incorporated by reference in its entirety. The wire conveyor belt provides a flat support surface, but is relatively expensive to produce and cumbersome to assemble. Further, the belt disclosed in the '972 patent is relatively difficult to repair or replace in the field. Still further, the plates of the '972 patent tend to slide laterally along the wire rods of the belt. Still further, the plates of the '972 patent are attached to the wire conveyor at leading and trailing edges of the plates, which can cause binding and/or allow the plates to slide relative to one another.

### SUMMARY

According to some aspects, a conveyor belt system includes a conveyor belt, the conveyor belt including a plurality of slat connection elements, such as spaced rods or rivets, and a plurality of slats. At least one of the slats in the plurality of slats includes a flat body portion having a top surface and a belt connection element, such as a rod or rivet connection element, extending from one end of the flat body portion.

According to another aspect, a food preparation or cooking device includes a housing, a heating element located within the housing, and a conveyor belt system. The conveyor belt system includes a conveyor belt having a plurality of slat connection elements, such as spaced rods or rivets, and a plurality of slats. At least one of the slats in the plurality of slats includes a flat body portion having a top surface and a belt connection element, such as a rod or rivet connection element, extending from one end of the flat body portion.

According to yet another aspect, a slat for a conveyor belt system includes a belt connection element, such as a rod or rivet connection element, extending from one end of the flat body portion. The belt connection connection element extends downward from a flat body portion of the slat in direction that is substantially perpendicular to a top surface of the slat and substantially perpendicular to a leading edge of the slat.

In accordance with the teachings of the disclosure, any one or more of the foregoing aspects of a conveyor belt system, a food preparation or cooking device, and/or a slat may further include any one or more of the following optional forms.

In some optional forms, the belt connection element includes a first planar portion and a second planar portion, the first planar portion being offset from, but substantially parallel to, the second planar portion.

In other optional forms, the first planar portion includes a first opening for receiving a portion of a rod or a rivet.

In other optional forms, the second planar portion includes a second opening for receiving a portion of a rod or a rivet.

In other optional forms, the first planar portion is connected to the second planar portion by a S-shaped connector.

In other optional forms, the S-shaped connector comprises an S-shaped cross section that includes two approximately 90 degree turns.

In other optional forms, the second planar portion forms a lateral stop, thereby preventing lateral movement of adjacent slats beyond the point at which the first planar portion of a second slat contacts the second planar portion of a first slat.

In other optional forms, a leading tab extends away from the top surface in a substantially perpendicular orientation.

In other optional forms, the leading tab is substantially perpendicular to the first and second planar portions.

In other optional forms, a trailing tab extends away from the top surface in a substantially perpendicular orientation.

In other optional forms, the trailing tab is substantially perpendicular to the first and second planar portions.

In other optional forms, at least one of the rods or rivets is shorter than a width of the at least one slat.

### BRIEF DESCRIPTION OF THE DRAWINGS

FIG. 1 is a top view of a segment of a conventional wire conveyor belt.

FIG. 2 is a side perspective view of the conventional wire conveyor belt of FIG. 1.

FIG. 3 is a top perspective view of a conveyor belt system constructed in accordance with the teachings of the disclosure, the conveyor belt system including a plurality of slats.

FIG. 4A is a top plan view of one embodiment of a slat from the conveyor belt system of FIG. 3.

FIG. 4B is a side elevational view of the slat of FIG. 4A.

FIG. 5 is close up view of an end of another embodiment of a slat from the conveyor belt system of FIG. 3.

FIG. 6 is an end perspective view of the conveyor belt system of FIG. 3, with the wire conveyor belt removed, illustrating the interaction of the ends of yet another embodiment of slats for the conveyor belt system.

FIG. 7 is a front view of a horizontal toaster including the conveyor belt system of FIG. 3.

FIG. 8 is a perspective view of a vertical toaster having an angled product feed chute and including the conveyor belt system of FIG. 3.

FIG. 9 is a perspective view of a vertical toaster having a vertical product feed chute and including the conveyor belt system of FIG. 3.

FIG. 10 is a perspective view of the vertical toaster of FIG. 9 with a cover removed revealing the conveyor belt system of FIG. 3.

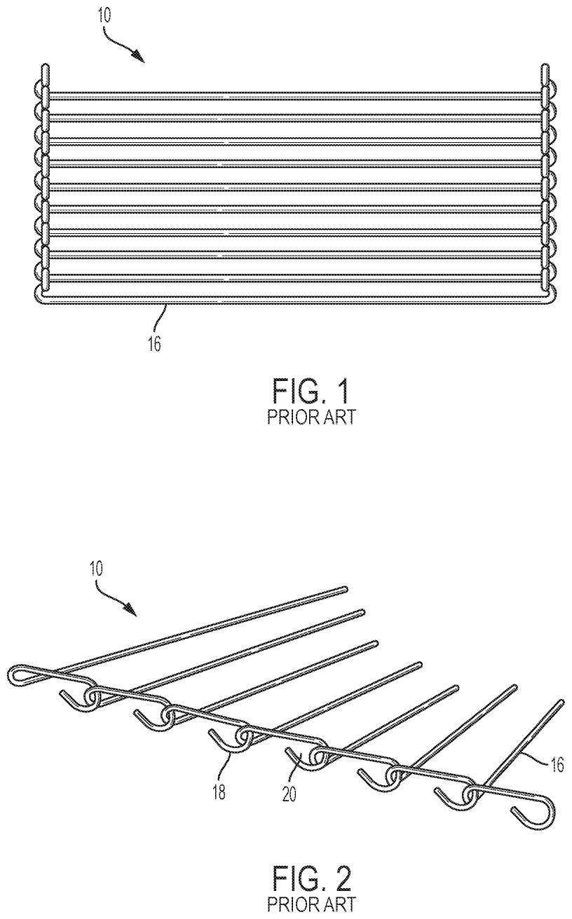

### DETAILED DESCRIPTION

A conveyor belt system includes a plurality of slats that supports a food product and moves the food product through a food preparation or cooking device, such as a toaster or oven, without substantially marking or pinching the food product. Additionally, the conveyor belt system with slats eases assembly of the conveyor belt system while also providing the ability to replace or repair individual slats in the field without the need for specialized tools. Individual slats may be made of any material that is durable enough to withstand temperatures within the food preparation device. Examples of slat materials include metals, such as copper, iron, aluminum, and nickel, and/or metal alloys such as steel, brass, and bronze. Stainless steel, for example AISI T-304, is one preferred material for manufacturing the slats.

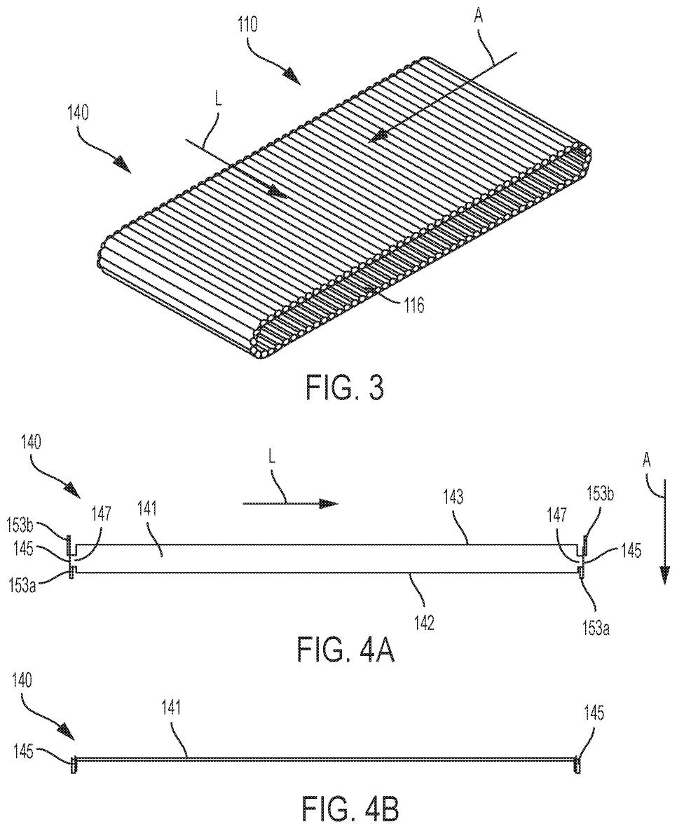

Turning now to FIGS. 3-6, a plurality of slats 140 is attached to spaced metal rods 116 of a wire conveyor belt to form a conveyor belt system 110. In other embodiments, the slats may be attached to one another with rivets or other fasteners that are shorter than the width of the slat 140. Each slat 140 includes a flat base portion 141 having a leading edge 142 and a trailing edge 143 relative to the direction of conveyance A. A lateral direction L is defined as being perpendicular to the direction of conveyance A. Each slat 140 also includes a rod connection element 145 at each lateral end of the flat base portion 141. The rod connection element 145 is attached to the flat base portion 141 by an extension 147, thereby leaving the leading and trailing edges 142, 143 free of any rod attachment device so that the leading and trailing edges form substantially continuous edges. In some embodiments, the leading and trailing edges may be chamfered to prevent pinching between slats 140. The rod connection element 145 forms a staked-end between slats 140 that secures the slat 140 to a conveyor belt by receiving a first metal rod 116 of the conveyor belt through a first opening 149a and by receiving a second metal rod 116 through a second opening 149b so that the slat 140 may be separated from the conveyor belt when desired by removing the first and second metal rods 116 from the first and second openings 149a, 149b. The rod connection element 145 leaves the leading edge 142 and the trailing edge 143 free of any attachment either with adjacent slats 140 or with the rods 116, so that adjacent slats 140 may partially rotate relative to one another, for example when rotating around a driving means, such as a sprocket.

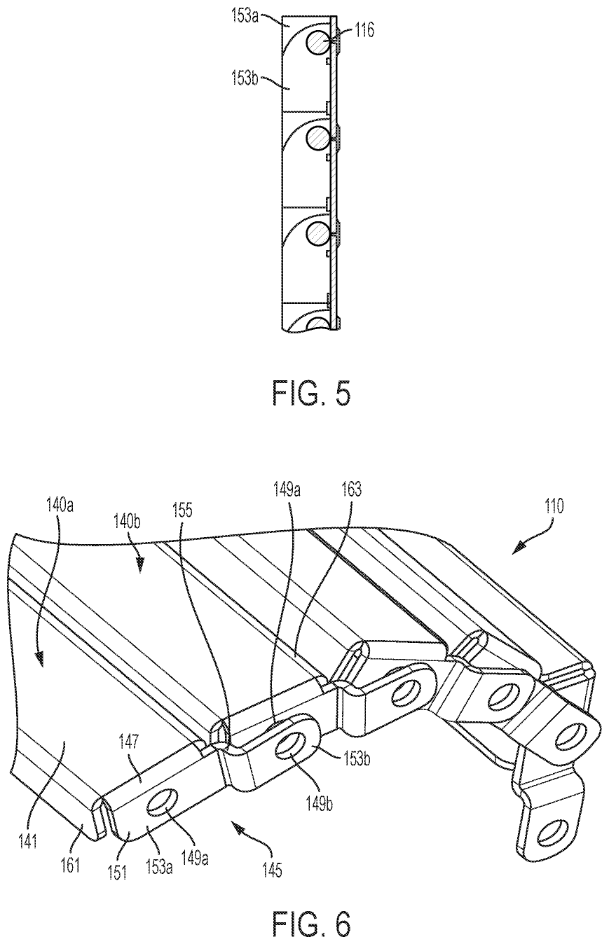

As illustrated in FIG. 6, the second opening 149b of a rod connection element 145 of a first slat 140a overlaps with a first opening 149a of a rod connection element 145 of a second slat 140b. Thus, a single metal rod 116 is disposed in the second opening 149b of the first slat 140a and in the first opening 149a of the second slat 140b at the same time when the plurality of slats 140 is attached to the wire rods 116 of the conveyor belt.

Each rod connection element 145 forms a downturned bracket 151 that extends downward, away from the top surface 141. The downturned bracket 151 includes a first planar portion 153a and a second planar portion 153b. The second planar portion 153b is offset, but generally parallel to, the first planar portion 153a, in a width direction of the slat 140. The second planar portion 153b is connected to the first planar portion 153a by an S-shaped connector 155. The S-shaped connector comprises an S-shaped cross section that includes two approximately 90 degree turns that results in the second planar portion 153b being offset from, but substantially parallel to, the first planar portion 153a. This offset orientation allows the second opening 149b of the rod connection element 145 of a first slat 140a to overlap with a first opening 149a of the rod connection element 145 of the second slat 140b, as described above. Thus, the metal rod 116 is advantageously connected to the first slat 140a and the second slat 140b simultaneously, while still allowing the first slat 140a to at least partially rotate about the metal rod 116 relative to the second slat 140b. Furthermore, the second planar portion 153b advantageously forms a lateral stop for the second slat 140b, which prevents the second slat 140b from moving laterally relative to the first slat 140a beyond the point at which the first planar portion 153a of the second slat 140b contacts the second planar portion 153b of the first slat 140a. Additionally, the rod connection elements 145, when connected to metal rods 116 of the conveyor belt, form a side edge chain, which further strengthens the conveyor belt system 110.

In another embodiment, the metal rods 116 need not extend the full width of the conveyor belt, but may comprise only metal posts or rivets that extend through the first and second openings 149a, 149b.

In any embodiment, the slats 140 may include leading tabs 161 and/or trailing tabs 163, which strengthen the slats 140 in a lateral (width-wise) bending direction. The leading and/or trailing tabs 161, 163 extend away from the top surface 141 in a substantially perpendicular orientation. The leading and/or trailing tabs 161, 163 are also substantially perpendicular to the first and second planar portions 153a, 153b.

In some embodiments, the conveyor belt comprises a plurality of spaced metal rods 116 disposed in succession and transversely with respect to a direction of conveyance. The plurality of spaced rods 116 form the wire conveyor belt which serves, in part, as a scaffolding for the plurality of removable slats 140. The wire conveyor belt also interacts with the drive mechanism, to move the rods 116 and the removable slats 140 through the food preparation or cooking device. Other scaffoldings capable of receiving removable slats 140 may also be used.

The slats 140 form a top side, or support side, and a bottom side. The top side forms a substantially flat support surface for conveying the food product, and the bottom side forms a platform that is at least partially supported by the rods 116. In some embodiments, the slats 140 may be welded to the rods 116 after installation.

The support surface is formed by the plurality of slats 140 which are coupled to selected rods 116 of the plurality of spaced metal rods 116. The slats 140 are secured at least partially to a first spaced rod 116 of the plurality of spaced rods 116 and to a second spaced rod 116, the second spaced rod 116 being separated from the first spaced rod 116. The first and second spaced rods 116 support the slat 140 so that the leading edge 142 and the trailing edge 143 extend beyond the first and second spaced rods 116, respectively, and the leading edge 142 and the trailing edge 143 are unsecured and free of any attachment, but supported along the bottom, thereby providing a joint that allows adjacent slats 140 to partially rotate relative to one another at the leading edge of each slat 140 and at the trailing edge of each slat 140.

The removable slats 140 are preferably formed from a metal material, such as stainless steel, or any other suitable material. In other embodiments, the removable slats 140 may be formed from extrudable materials including, but not limited to, polymers and ceramics. Exemplary metals include, but are not limited to, aluminum, brass, copper, magnesium, and steel. Aluminum alloys such as hard coated anodized aluminum, for example AA 6063-T6, are preferred. Exemplary plastics include, but are not limited to, polyvinylchlorides, polyethylenes, polypropylenes, acetals, acrylics, nylons (polyamides), polystyrene, acrylonitrile butadiene styrenes, and polycarbonates.

In the conveyor belt systems 110 of FIGS. 3-6, the top surfaces of the removable slats 140 are generally smooth. The top surfaces may, however, be corrugated or textured to better grip an item. In other embodiments, the top surfaces of the removable slats 140 may include gripping features to retain an item while the item is transported to facilitate the frictional engagement of food product carried thereon. The roughness of the surface of the removable slats 140 in one embodiment may be provided by shot peening the surfaces of the slats 140 using a predetermined shot size, as is disclosed in U.S. Patent Publication No. 2010/0275789, which is herein incorporated by reference in its entirety. Alternatively, the surface of the removable slat 140 may have gripping features such as an abrasive coating, dimples, furrows, or protrusions that would be strong enough to grip the food product, but not so abrasive that the gripping features rip, tear, or mark the food product.

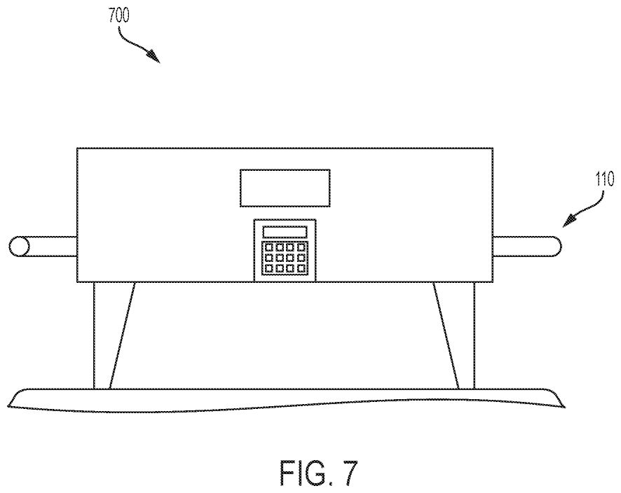

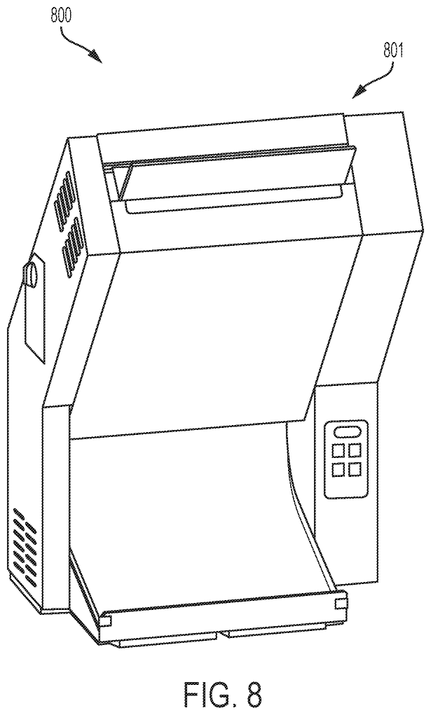

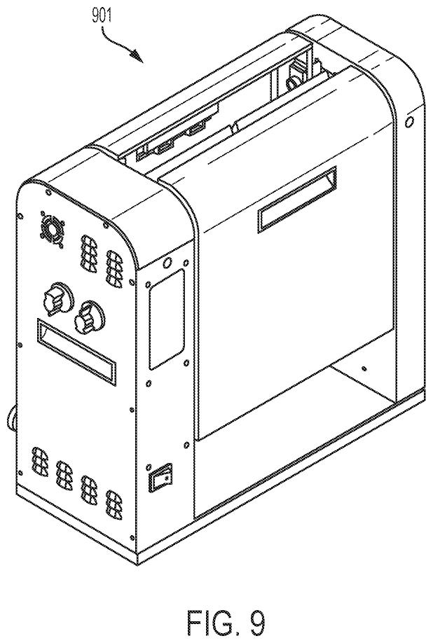

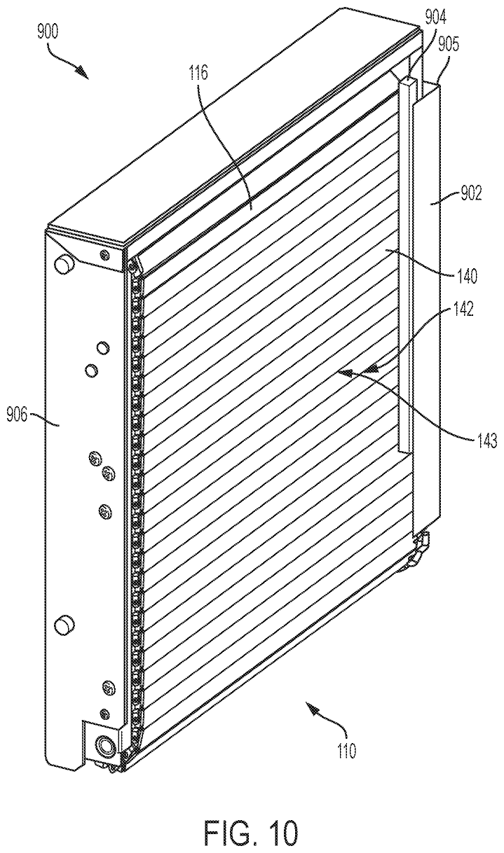

The conveyor belt system 110 may be used in a horizontal toaster 700 as illustrated in FIG. 7, an angled toaster 800 as illustrated in FIG. 8, or a vertical toaster 901 as illustrated in FIG. 9.

Existing conveyor toasters usually include a product feed where the product is inserted into an opening of the toaster. For example, in the angled toaster 800 in FIG. 8, the product travels down an angled shoot 801, usually angled at about 45 degrees, and is received by a conveyor belt system (not shown in FIG. 8). The conveyor belt system receives the food product and urges it through an opening between the conveyor belt and a heated platen. In some conveyor toasters, the food product is compressed through this opening between the platen and the conveyor belt, also called a compressive gap, to process the food product.

The disclosed conveyor belt systems 110 may be used in a vertical toaster 901, as illustrated in FIG. 9. The vertical toaster 901, an example of which is disclosed in U.S. Patent Publication No. 2010/02757789, has a removable and adjustable conveyor belt that receives a food product at an opening at the top of the toaster. As illustrated in FIG. 9, a vertical conveyor belt system 110 may include a guide structure 902 that runs the full length of the conveyor belt. In one embodiment, the conveyor belt system 110 may include a guide structure 902 on both ends of the conveyor belt. A guide bar 904 may be fixed to a bracket 905 that attaches the guide bar 904 to the conveyor belt housing 906. The vertical toaster 901 includes a heating element (not shown), such as a heated platen, for example.

In accordance with a preferred embodiment of the conveyor belt system, the compression gap can be adjusted according to varying sizes of food product. In one embodiment, the conveyor belt can be adjusted with respect to the reactive surface as illustrated and explained in U.S. Patent Publication No. 2010/0275789.

While the present invention has been described with respect to a particular embodiment of the present invention, this is by way of illustration for purposes of disclosure rather than to confine the invention to any specific arrangement as there are various alterations, changes, deviations, eliminations, substitutions, omissions and departures which may be made in the particular embodiment shown and described without departing from the scope of the claims.

What is claimed is:

1. A conveyor belt system for moving a food product through a food preparation device, the conveyor belt system comprising:
a slat connection mechanism including one of a rod or a rivet; and
a plurality of slats, at least one of the slats in the plurality of slats including a flat body portion having a top surface and a connection element extending from one end of the flat body portion, the connection element forming a staked-end of the at least one slat when connected to the one of the rod or the rivet.

2. The conveyor belt system of claim 1, wherein the connection element extends downward from the flat body portion in direction that is substantially perpendicular to the top surface and substantially perpendicular to a leading edge of the at least one slat.

3. The conveyor belt system of claim 2, wherein the connection element includes a first planar portion and a second planar portion, the first planar portion being offset from, but substantially parallel to, the second planar portion.

4. The conveyor belt system of claim 3, wherein the first planar portion includes a first opening for receiving a portion of the rod or the rivet.

5. The conveyor belt system of claim 3, wherein the second planar portion includes a second opening for receiving a portion of the rod or the rivet.

6. The conveyor belt system of claim 3 wherein the first planar portion is connected to the second planar portion by an S-shaped connector.

7. The conveyor belt system of claim 6, wherein the S-shaped connector comprises an S-shaped cross section that includes two approximately 90 degree turns.

8. The conveyor belt system of claim 7, wherein the second planar portion forms a lateral stop, thereby preventing lateral movement of adjacent slats beyond the point at which the first planar portion of a second slat contacts the second planar portion of a first slat.

9. The conveyor belt system of claim 2, further comprising a leading tab that extends downward, away from the top surface in a substantially perpendicular orientation.

10. The conveyor belt system of claim 9, wherein the leading tab is substantially perpendicular to the first and second planar portions.

11. The conveyor belt system of claim 2, further comprising a trailing tab that extends downward, away from the top surface in a substantially perpendicular orientation.

12. The conveyor belt system of claim 11, wherein the trailing tab is substantially perpendicular to the first and second planar portions.

13. The conveyor belt system of claim 1, wherein the rod or the rivet is shorter than a width of the at least one slat.

14. A food preparation device comprising:
a housing;
a heating element located within the housing; and
a conveyor belt, the conveyor belt comprising a slat connection mechanism including one of a rod or a rivet; and
a plurality of slats, at least one of the slats in the plurality of slats including a flat body portion having a top surface and a connection element extending from one end of the flat body portion, the connection element forming a staked-end of the at least one slat when connected to the rod or the rivet.

15. A slat for a conveyor belt system, the slat comprising:
a connection element extending from one end of a flat body portion, the connection element extending downward from a flat body portion in direction that is substantially perpendicular to a top surface and substantially perpendicular to a leading edge, the connection element forming a staked-end of the slat when connected to at least one of a rod or a rivet.

16. The conveyor belt system of claim 15, wherein the connection element includes a first planar portion and a second planar portion, the first planar portion being offset from, but substantially parallel to, the second planar portion.

17. The conveyor belt system of claim 16, wherein the first planar portion includes a first opening for receiving a portion of the rod or the rivet.

18. The conveyor belt system of claim 17, wherein the second planar portion includes a second opening for receiving a portion of the rod or the rivet.

19. The conveyor belt system of claim 3 wherein the first planar portion is connected to the second planar portion by a S-shaped connector, the S-shaped connector comprises an S-shaped cross section that includes two approximately 90 degree turns.
